(19) United States
(12) Patent Application Publication
(10) Pub. No.: US 2025/0288947 A1
(43) Pub. Date: Sep. 18, 2025

(54) METHOD FOR PRODUCING ACIDIC GAS ABSORBENT AND ACIDIC GAS ABSORBENT PRODUCED BY THE METHOD

(71) Applicant: KOREA INSTITUTE OF ENERGY RESEARCH, Daejeon (KR)

(72) Inventors: Sung Chan Nam, Daejeon (KR); II Hyun Baek, Daejeon (KR)

(73) Assignee: KOREA INSTITUTE OF ENERGY RESEARCH, Daejeon (KR)

(21) Appl. No.: 18/630,340

(22) Filed: Apr. 9, 2024

(30) Foreign Application Priority Data
Mar. 12, 2024 (KR) 10-2024-0034327

(51) Int. Cl. B01D 53/14; B01D 3/14; B01D 53/62; B01D 53/78; B01D 53/96

(52) U.S. Cl. CPC B01D 53/1493; B01D 3/143; B01D 53/1425; B01D 53/1475; B01D 53/62; B01D 53/78; B01D 53/96; B01D 2252/103; B01D 2252/20405; B01D 2252/20421; B01D 2252/20426; B01D 2252/20431; B01D 2252/20484; B01D 2252/20489; B01D 2252/504; B01D 2257/504

(57) ABSTRACT

The present invention relates to a method for producing a mixed absorbent without a separate purification process in order to produce an absorbent that has excellent ability to absorb acidic gases including carbon dioxide and a fast reaction rate through an efficient process, and an absorbent produced by the method. The acidic gas absorbent of the present invention has excellent acidic gas absorption ability and a fast reaction rate as well as the process is simple and economical since an efficient process is adopted so that the separation and purification processes of reactants are omitted to produce the absorbent.

### BACKGROUND OF THE INVENTION

### Field of the Invention

The present invention relates to a method for producing an acidic gas absorbent and an absorbent produced by the method, more specifically to a method for producing an absorbent only through a mixing process without separate additional processes including purification or addition in order to produce an absorbent that has excellent ability to absorb acidic gases including carbon dioxide and a fast reaction rate through an efficient process, and an absorbent produced by the method.

### Description of the Related Art

Carbon dioxide (CO₂) emissions, which had been gradually increasing since the Industrial Revolution, have increased rapidly with the increase in the use of fossil fuels since the 1940s when full-scale industrial development began. In particular, by 2022, CO₂ emissions reached a new high of over 36.8 Gt. CO₂ is a representative greenhouse gas that causes global warming and climate change problems in modern times and is now affecting human survival. Therefore, it is greatly important to decrease the CO₂ amount for the future and survival of humanity. CO₂ capture is the technology to decrease the CO₂ amount the most in the short to medium term. Adsorption, absorption, membrane, and cryogenic separation are currently used CO₂ capture technologies that can separate CO₂ from exhaust gas. In particular, chemical absorption using alkanolamines has advantages of high CO₂ reactivity, high absorption rate, and simple process design under low-concentration CO₂ conditions in exhaust gas and is thus commercial and the most advanced technology. However, there are still difficulties in applying chemical absorption to a process on a larger scale because of problems such as high regeneration energy of the absorbent, denaturation of the absorbent, and corrosion of the process equipment. Chemical absorption using alkanolamines is a circulation process including absorption and regeneration of the absorbent in the absorption tower and stripping tower. The absorbent and CO₂ react to form a CO₂-rich solution in the absorption tower at a low temperature (about 50° C.), and the CO₂-rich solution then moves to the stripping tower, where thermal regeneration of the CO₂-rich solution occurs at a high temperature (about 120° C.) to form a CO₂-stripped absorbent, a CO₂-lean solution, which is then returned to the absorption tower for circulation. A reboiler is required to maintain the temperature of the stripping tower, and the cost for this accounts for approximately 80% of the total process cost. Hence, it is an important point to cut down the energy required for the absorbent regeneration process for expansion and application of the process.

There are various methods for separation and recovery of acidic gases, including carbon dioxide, such as absorption, adsorption, membrane separation, and deep cooling, and various absorption methods suitable for separation of a large volume of gas and gas with a low concentration are studied. Ethanolamine is used to capture carbon dioxide through absorption, and there are ethanolamines such as monoethanolamine (MEA), which is a primary amine, diethanolamine (DEA), which is a secondary amine, triethanolamine (TEA), which is a tertiary amine, N-methyl diethanolamine (MDEA), and triisopropanolamine (TIPA).

In a case where monoethanolamine or diethanolamine, which is most basic and has a small equivalent, is used as an absorbent among these, the reaction rate is fast but a large amount of energy is consumed to strip carbon dioxide. The amount of absorbent liquid used is large and the equipment is corroded by the absorbent liquid. MDEA is less corrosive and requires less heat for regeneration, but has a disadvantage of a low absorption speed.

In order to solve such problems, Korean Patent No. 1746561 [Carbon dioxide absorbent and method for regenerating carbon dioxide absorbent] discloses technology for a carbon dioxide absorbent formed of a diamine compound containing primary and tertiary amines. However, there are still problems that the absorption speed is slow and an additional process of adding an additional solvent is required.

Hence, in the present invention, based on this point of view, it is intended to provide an efficient production method of an acidic gas absorbent by which the absorbent is produced only through a synthesis process without additional processes such as a separate purification process or addition, and an absorbent produced by the method.

### CITATION LIST

### Patent Literature

Patent Literature 1: Korean Patent No. 1746561

### SUMMARY OF THE INVENTION

Accordingly, a technical object to be achieved by the present invention is to provide an efficient production method of an acidic gas absorbent by which the absorbent, which has excellent acidic gas absorption ability and a fast reaction rate, is produced only through a synthesis process without additional processes such as a separate purification process or addition, and an absorbent produced by the method.

However, the technical objects to be achieved by the present invention are not limited to the technical object mentioned above, and other technical objects that are not mentioned will be clearly understood by those skilled in the art to which the present invention pertains from the description below.

In order to achieve the technical objects, an aspect of the present invention provides a method for producing an acidic gas absorbent, the method including: supplying water and ammonia to a first mixer to produce a first mixture; supplying the first mixture in the first mixer to a second mixer through a first mixer discharge pipe and simultaneously supplying ethylene oxide to the second mixer to form a second mixture; supplying the second mixture in the second mixer to a reactor through a second mixer discharge pipe and reacting the second mixture under predetermined temperature and pressure conditions to form a third mixture; supplying the third mixture in the reactor to a first separator equipped with a distillation tower function through a reactor discharge pipe and separating the third mixture into unreacted ammonia, water vapor, and a fourth mixture; recovering unreacted ammonia and water vapor in the first separator into the first mixer through a first separator distillation tower connection pipe and supplying the fourth mixture to a second separator equipped with a distillation tower function through a first separator discharge pipe and separating the fourth mixture into unreacted water and a fifth mixture; and recovering a portion of unreacted water in the second separator as water vapor into the first mixer through a second separator distillation tower connection pipe and obtaining the fifth product as an acidic gas absorbent through a second separator discharge pipe, in which a molar ratio of ammonia supplied to the first mixer and unreacted ammonia recovered through the first separator distillation tower connection pipe to ethylene oxide supplied to the second mixer is 5:1 to 10:1, and the predetermined temperature and pressure conditions are 50° C. to 70° C. and 3 to 15 bar, respectively.

A temperature range in the first separator may be 50° C. to 170° C. and a pressure range may be 2 to 6 bar.

A temperature range in the second separator may be 80° C. to 150° C. and a pressure range may be 0 to 1.2 bar.

Another aspect of the present invention provides an acidic gas absorbent produced by the method according to any one of clauses 1 to 3.

The acidic gas absorbent may contain monoethanolamine at 10 to 60 wt %, diethanolamine at 20 to 70 wt, triethanolamine at 15 to 60 wt %, and water at 10 to 40 wt % with respect to a total weight.

Still another aspect of the present invention provides a carbon dioxide capturing method using an acidic gas absorbent, the method including: preparing an aqueous solution containing an acidic gas absorbent produced by the method according to clause 1 (S100); and capturing carbon dioxide using the aqueous solution (S200), in which heat of reaction generated by a reaction between the aqueous solution and carbon dioxide is 74 KJ/mol-CO₂ or less.

The aqueous solution in step S100 may contain the acidic gas absorbent according to clause 4 at 50 to 60 wt %.

Step S200 may involve capturing carbon dioxide in a temperature range of 30° C. to 50° C. and a pressure range of 1.5 bar or less.

An absorption rate may be 0.0024 mol CO₂/min or more when 10 minutes has elapsed after exposure of the acidic gas absorbent to carbon dioxide in step S200.

The carbon dioxide capturing method using an acidic gas absorbent may further include desorbing the captured carbon dioxide and regenerating the acidic gas absorbent (S300) after step S200.

The acidic gas absorbent may have a maximum desorption rate of 0.0020 mol CO₂/min or more and 0.0025 mol CO₂/min or less in step S300.

Another aspect of the present invention provides a method for producing an acidic gas absorbent, the method including: supplying water and ammonia to a first mixer to produce a first reactant; simultaneously supplying ethylene oxide and the first reactant to a second reactor through a supply pipe connected to a first connection pipe that supplies the first reactant in the first reactor to the second reactor to form a second reactant; supplying the second reactant in the second reactor to a third reactor equipped with a distillation tower function through a second connection pipe and separating the second reactant into unreacted ammonia and a third reactant; recovering unreacted ammonia in the third reactor to the first reactor through a third connection pipe, supplying the third reactant to a fourth reactor equipped with a distillation tower function through a fourth connection pipe, and separating the third reactant into unreacted water and a fourth reactant; and recovering unreacted water in the fourth reactor to the first reactor through a fifth connection pipe and obtaining the fourth reactant as an acidic gas absorbent through a fourth reactor discharge pipe, in which a molar ratio of total ammonia, including ammonia supplied to the first reactor and unreacted ammonia recovered through the third connection pipe, to ethylene oxide supplied through the supply pipe is 5:1 to 10:1.

A temperature range in the second reactor may be 50° C. to 70° C. and a pressure range may be 0.5 to 1.5 MPa.

Still another aspect of the present invention provides an acidic gas absorbent produced by the method according to clause 12 or 13.

The acidic gas absorbent may contain monoethanolamine at 20 to 70 wt %, diethanolamine at 10 to 20 wt %, and triethanolamine at 5 to 75 wt % with respect to a total weight.

### BRIEF DESCRIPTION OF THE DRAWINGS

FIG. 1 is a conceptual diagram illustrating a process of producing a mixed absorbent using an aqueous ammonia solution and ethylene oxide according to an exemplary embodiment of the present invention;

FIG. 2 is a conceptual diagram illustrating a process of producing a mixed absorbent using an aqueous ammonia solution and ethylene oxide according to an exemplary embodiment of the present invention;

FIG. 3 illustrates a carbon dioxide adsorption curve of an acidic gas absorbent according to an embodiment of the present invention;

FIG. 4 illustrates the carbon dioxide absorption ability (absorption rate) of an acidic gas absorbent according to an exemplary embodiment of the present invention;

FIG. 5 illustrates the carbon dioxide absorption rate of an acidic gas absorbent according to an exemplary embodiment of the present invention when 10 minutes has elapsed after exposure of the acidic gas absorbent to carbon dioxide;

FIG. 6 illustrates a carbon dioxide desorption curve of an acidic gas absorbent according to an exemplary embodiment of the present invention;

FIG. 7 illustrates the carbon dioxide desorption ability (desorption rate) of an acidic gas absorbent according to an exemplary embodiment of the present invention;

FIG. 8 illustrates the maximum carbon dioxide desorption rate of an acidic gas absorbent according to an exemplary embodiment of the present invention;

FIG. 9 illustrates data related to absorption and desorption (regeneration) of an acidic gas absorbent according to an exemplary embodiment of the present invention; and

FIG. 10 illustrates a schematic diagram of an absorption equilibrium device fabricated to measure the carbon dioxide absorption ability of an acidic gas absorbent.

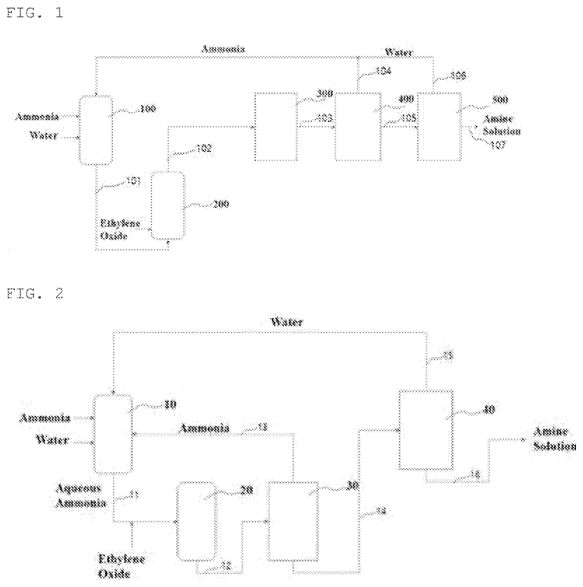

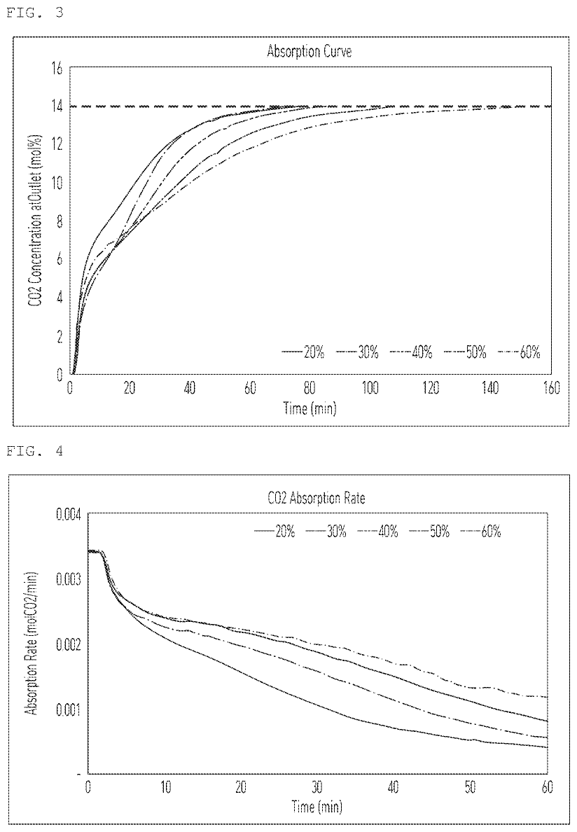

### DETAILED DESCRIPTION OF THE PREFERRED EMBODIMENTS

Hereinafter, the present invention will be described in more detail with reference to the attached drawings. However, the present invention may be implemented in various different forms and, therefore, is not limited to the embodiments described herein. In order to clearly explain the present invention in the drawings, parts that are not related to the description are omitted, and similar reference numerals are given to similar parts throughout the specification.

Throughout the specification, when a part is said to be “connected (linked, in contact, combined)” with another part, this includes not only cases where the parts are “directly connected” but also cases where the parts are “indirectly connected” with another member in between. When a part is said to “include” a certain component, this means that the part does not exclude other components but may further include other components, unless specifically stated to the contrary.

The terms used herein are only used to describe specific embodiments and are not intended to limit the present invention. Singular expressions include plural expressions unless the context clearly dictates otherwise. In this specification, it should be understood that terms such as “include” or “have” are intended to indicate the presence of features, numbers, steps, operations, components, parts, or combinations thereof described in the specification but do not preclude the presence or addition possibility of one or more other features, numbers, steps, operations, components, parts, or combinations thereof.

In describing the present invention, in a case where it is determined that a detailed description of a related known configuration or function may obscure the gist of the present invention, the detailed description may be omitted.

A first aspect of the present disclosure provides a method for producing an acidic gas absorbent, the method including: supplying water and ammonia to a first mixer to produce a first mixture; supplying the first mixture in the first mixer to a second mixer through a first mixer discharge pipe and simultaneously supplying ethylene oxide to the second mixer to form a second mixture; supplying the second mixture in the second mixer to a reactor through a second mixer discharge pipe and reacting the second mixture under predetermined temperature and pressure conditions to form a third mixture; supplying the third mixture in the reactor to a first separator equipped with a distillation tower function through a reactor discharge pipe and separating the third mixture into unreacted ammonia, water vapor, and a fourth mixture; recovering unreacted ammonia and water vapor in the first separator into the first mixer through a first separator distillation tower connection pipe and supplying the fourth mixture to a second separator equipped with a distillation tower function through a first separator discharge pipe and separating the fourth mixture into unreacted water and a fifth mixture; and recovering a portion of unreacted water in the second separator as water vapor into the first mixer through a second separator distillation tower connection pipe and obtaining the fifth product as an acidic gas absorbent through a second separator discharge pipe, in which a molar ratio of ammonia supplied to the first mixer and unreacted ammonia recovered through the first separator distillation tower connection pipe to ethylene oxide supplied to the second mixer is 5:1 to 10:1, and the predetermined temperature and pressure conditions are 50° C. to 70° C. and 3 to 15 bar, respectively.

Hereinafter, the method for producing an acidic gas absorbent according to the first aspect of the present disclosure will be described.

In an exemplary embodiment of the present disclosure, primary amines such as monoethanolamine (MEA) and secondary amines such as diethanolamine (DEA) generally follow the following mechanism.

CO₂₊₂RNH₂↔RNHCOO⁻+RNH₃⁺

Tertiary amines such as triethanolamine (TEA) follow the reaction mechanism below since the above reaction path is unstable.

CO₂+R3N+H₂O↔R₃NH⁺+HCO₃⁻

Therefore, two amines are required to absorb one carbon dioxide in the case of primary and secondary amines while one amine is required to absorb one carbon dioxide in the case of tertiary amines, so tertiary amines have an absorption capacity to be two times that of primary or secondary amines. An absorbent in which primary, secondary and tertiary amines are mixed has highly efficient carbon dioxide absorption ability, and an aqueous ammonia solution and ethylene oxide are synthesized to improve the method for producing each of primary, secondary, and tertiary amines and mixing the amines together to form such a mixed absorbent. In the present invention, by adopting an intermediate product of amine without a separate purification process in the synthesis process, a separation material for an economical acidic gas capture process is obtained through a simpler process than that for an amine product produced after final separation and purification. The acidic gas of the present invention includes, but are not limited to, carbon dioxide, hydrogen sulfide, and sulfur oxides. Hereinafter, the present invention will be described in detail with reference to the drawings.

In an exemplary embodiment of the present disclosure, FIG. 1 is a conceptual diagram illustrating a process of producing a mixed absorbent using an aqueous ammonia solution and ethylene oxide according to another exemplary embodiment of the present invention. The present invention is a method for producing an acidic gas absorbent, which includes: supplying water and ammonia to a first mixer 100 to produce a first mixture; supplying the first mixture in the first mixer to a second mixer 200 through a first mixer discharge pipe 101 and simultaneously supplying ethylene oxide to the second mixer to form a second mixture; supplying the second mixture in the second mixer to a reactor 300 through a second mixer discharge pipe 102 and reacting the second mixture under predetermined temperature and pressure conditions to form a third mixture; supplying the third mixture in the reactor to a first separator 400 equipped with a distillation tower function through a reactor discharge pipe 103 and separating the third mixture into unreacted ammonia, water vapor, and a fourth mixture; recovering unreacted ammonia and water vapor in the first separator into the first mixer through a first separator distillation tower connection pipe 104 and supplying the fourth mixture to a second separator 500 equipped with a distillation tower function through a first separator discharge pipe 105 and separating the fourth mixture into unreacted water and a fifth mixture; and recovering a portion of unreacted water in the second separator as water vapor into the first mixer through a second separator distillation tower connection pipe 106 and obtaining the fifth product as an acidic gas absorbent through a second separator discharge pipe 107.

In an exemplary embodiment of the present disclosure, the molar ratio of ammonia supplied to the first mixer and unreacted ammonia recovered through the first separator distillation tower connection pipe to ethylene oxide supplied to the second mixer is 5:1 to 10:1. Ammonia and water are supplied from outside the first mixer, and operating conditions are maintained at room temperature and normal pressure. Ethylene oxide is an explosive substance and it is dangerous to handle ethylene oxide remaining after the reaction with ammonia, so it is preferable to add ammonia in an excessive amount compared to the amount of ethylene oxide.

In an exemplary embodiment of the present disclosure, the reaction between the ethylene oxide and the ammonia solution is conducted at an excessive equivalent of ammonia in the reaction equivalence ratio of ethylene oxide to ammonia so that the reaction sufficiently takes place in the reactor. The predetermined temperature and pressure conditions in the reactor are 50° C. to 70° C. and 3 to 15 bar, respectively.

In an exemplary embodiment of the present disclosure, the temperature range in the first separator is 50° C. to 170° C. and the pressure range is 2 to 6 bar. The main purpose of the first separator is to separate ammonia from the amine solution synthesized in the reactor. In order to maximize the reaction of ethylene glycol in the upper reactor, excess ammonia solution is injected, and unreacted ammonia remains and is separated. The separated ammonia gas and a portion of water vapor are recirculated to the first mixer.

In an exemplary embodiment of the present disclosure, the temperature range in the second separator is 80° C. to 150° C. and the pressure range is 0 to 1.2 bar. The purpose of the second separator is mainly to remove water from the synthesized amine mixed solution, but can completely separate ammonia that has not been completely separated in the first separator.

A second aspect of the present disclosure provides an acidic gas absorbent produced by the method according to any one of clauses 1 to 3.

Detailed description of parts overlapping with those of the first aspect of the present disclosure has been omitted, but the description of the first aspect of the present disclosure can be applied equally even if the description is omitted in the second aspect.

In an exemplary embodiment of the present disclosure, the acidic gas absorbent produced by the method according to any one of clauses 1 to 3 may be a synthesized amine mixed solution and may contain monoethanolamine at 10 to 60 wt %, diethanolamine at 20 to 70 wt, triethanolamine at 15 to 60 wt %, and water at 10 to 40 wt % with respect to the total weight.

A third aspect of the present disclosure provides a carbon dioxide capturing method using an acidic gas absorbent, the method including: preparing an aqueous solution containing an acidic gas absorbent produced by the method according to clause 1 (S100); and capturing carbon dioxide using the aqueous solution (S200), in which heat of reaction generated by a reaction between the aqueous solution and carbon dioxide is 74 KJ/mol-CO₂ or less.

Detailed description of parts overlapping with those of the first and second aspects of the present disclosure has been omitted, but the description of the first and second aspects of the present disclosure can be applied equally even if the description is omitted in the third aspect.

Hereinafter, the carbon dioxide capturing method using an acidic gas absorbent according to the third aspect of the present disclosure will be described in detail.

First, in an exemplary embodiment of the present disclosure, the aqueous solution in step S100 may contain the acidic gas absorbent according to clause 4 at 50 to 60 wt %. In a case where the content of the acidic gas absorbent is less than the above range, sufficient carbon dioxide adsorption may not occur.

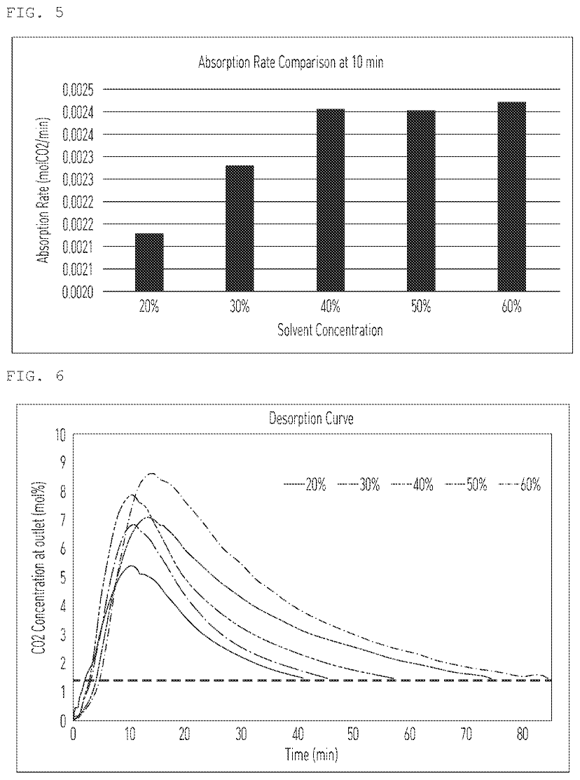

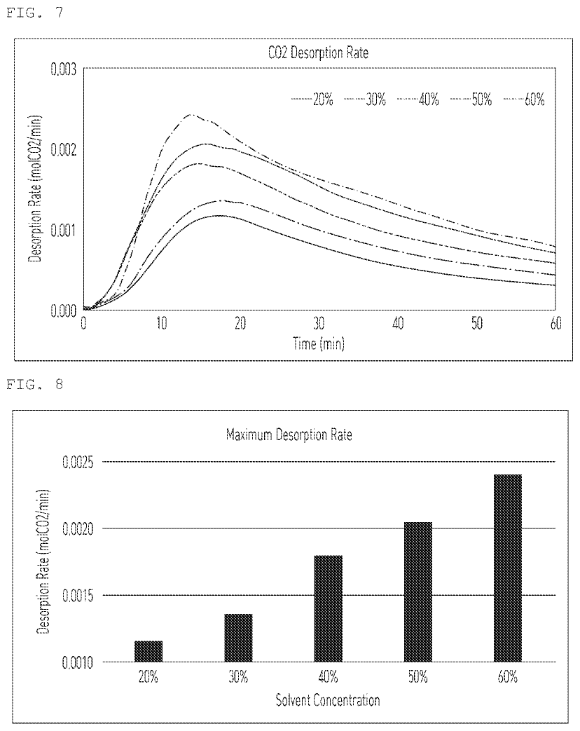

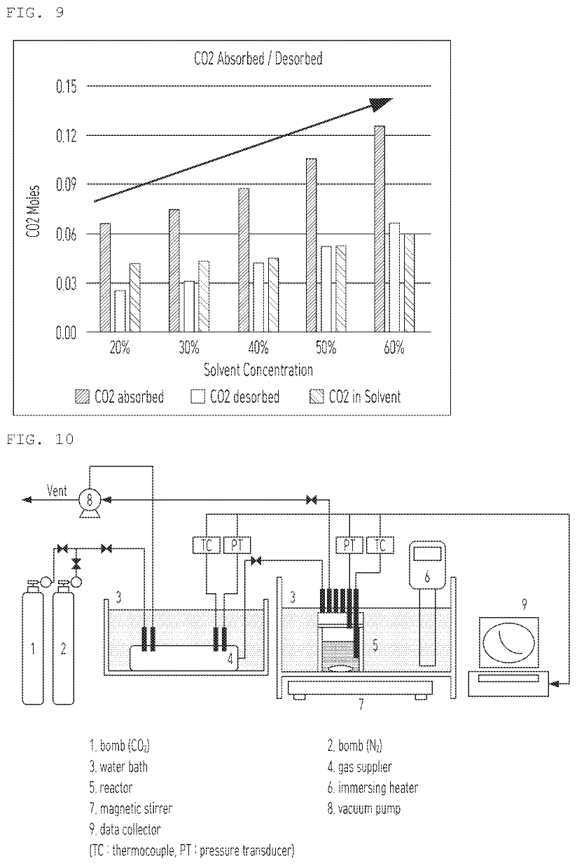

In an exemplary embodiment of the present disclosure, step S200 may involve capturing carbon dioxide in a temperature range of 30° C. to 50° C. and a pressure range of 1.5 bar or less, and the absorption rate may be 0.0024 mol CO₂/min or more when 10 minutes has elapsed after exposure of the acidic gas absorbent to carbon dioxide in step S200. The results are illustrated in FIG. 5, and it can be seen that the absorption rate is relatively low in a case where the content of the acidic gas absorbent in the aqueous solution is insufficient.

In an exemplary embodiment of the present disclosure, the carbon dioxide capturing method using an acidic gas absorbent may further include desorbing the captured carbon dioxide and regenerating the acidic gas absorbent (S300) after step S200, and the acidic gas absorbent may have a maximum desorption rate of 0.0020 mol CO₂/min or more and 0.0025 mol CO₂/min or less in step S300. The results are illustrated in FIG. 8, and it can be seen that the desorption rate is relatively low in a case where the content of the acidic gas absorbent in the aqueous solution is insufficient.

A fourth aspect of the present disclosure provides a method for producing an acidic gas absorbent, the method including: supplying water and ammonia to a first mixer to produce a first reactant; simultaneously supplying ethylene oxide and the first reactant to a second reactor through a supply pipe connected to a first connection pipe that supplies the first reactant in the first reactor to the second reactor to form a second reactant; supplying the second reactant in the second reactor to a third reactor equipped with a distillation tower function through a second connection pipe and separating the second reactant into unreacted ammonia and a third reactant; recovering unreacted ammonia in the third reactor to the first reactor through a third connection pipe, supplying the third reactant to a fourth reactor equipped with a distillation tower function through a fourth connection pipe, and separating the third reactant into unreacted water and a fourth reactant; and recovering unreacted water in the fourth reactor to the first reactor through a fifth connection pipe and obtaining the fourth reactant as an acidic gas absorbent through a fourth reactor discharge pipe, in which a molar ratio of total ammonia, including ammonia supplied to the first reactor and unreacted ammonia recovered through the third connection pipe, to ethylene oxide supplied through the supply pipe is 5:1 to 10:1.

Detailed description of parts overlapping with those of the first to third aspects of the present disclosure has been omitted, but the description of the first to third aspects of the present disclosure can be applied equally even if the description is omitted in the fourth aspect.

Hereinafter, the method for producing an acidic gas absorbent according to the fourth aspect of the present disclosure will be described in detail.

In an exemplary embodiment of the present disclosure, the reaction between the ethylene oxide and the ammonia solution is conducted at an excessive equivalent of ammonia in the reaction equivalence ratio of ethylene oxide to ammonia so that the reaction sufficiently takes place in the second reactor. The temperature range in the second reactor may be 50° C. to 70° C. and the pressure range may be 0.5 to 1.5 MPa.

A fifth aspect of the present disclosure provides an acidic gas absorbent produced by the method according to clause 12 or 13.

Detailed description of parts overlapping with those of the first to fourth aspects of the present disclosure has been omitted, but the description of the first to fourth aspects of the present disclosure can be applied equally even if the description is omitted in the fifth aspect.

In an exemplary embodiment of the present disclosure, the acidic gas absorbent produced by the method according to clause 12 or 13 may contain monoethanolamine at 20 to 70 wt %, diethanolamine at 10 to 20 wt %, and triethanolamine at 5 to 75 wt % with respect to the total weight.

Hereinafter, Examples of the present invention will be described in detail so that those skilled in the art to which the present invention pertains can easily implement the present invention. However, the present invention may be implemented in various different forms and is not limited to Examples described herein.

### Example 1: Average Composition Depending on Absorbent Production Process

In a case where an acidic gas absorbent is produced by the production methods described above, the composition ratio of the respective components converges within a certain range. The results of production by the methods illustrated in FIG. 1 and the description below are as presented in Table 1.

TABLE 1

| Order | 1 | 2 | 3 | 4 | 5 | Average (%) |
|---|---|---|---|---|---|---|
| MEA | 25.9 | 22.6 | 20.4 | 20.1 | 19.7 | 21.7 |
| DEA | 34.6 | 33.5 | 34.3 | 35.1 | 34.9 | 34.5 |
| TEA | 22.9 | 27.2 | 28.1 | 26.7 | 27.6 | 26.5 |
| H₂O | 16.6 | 16.7 | 17.2 | 18.1 | 17.8 | 17.3 |
| Total (%) | 100.0 | 100.0 | 100.0 | 100.0 | 100.0 | 100.0 |

This mixed solution is an intermediate product in the amine production process, and is cheaper and produced through a simpler process than an amine product produced after final separation and purification, thus functions as a separation material in the capture process of acidic gases, including carbon dioxide, hydrogen sulfide, and sulfur oxides, and can significantly cut down the process operating cost compared to conventional simple synthesis.

### Example 2: Carbon Dioxide Capture and Desorption Using Acidic Gas Absorbent

A carbon dioxide capture operation was performed using the acidic gas absorbents produced by the production methods described above. Aqueous solutions were prepared using 20% (containing acidic gas absorbent at 20%+water at 80%), 30%, 40%, 50%, and 60% acidic gas absorbents, then vapor-liquid experiments were performed, and the results are as follows. At this time, the adsorption and desorption experiment conditions are as presented in Table 2 below.

TABLE 2

| Adsorption | | | Desorption | | |
|---|---|---|---|---|---|
| Temperature | 40 | ° C. | Temperature | 90 | ° C. |
| Pressure | 1 | Bar | Pressure | 1 | Bar |
| Flowrate | 588 | cc/min | Flowrate | — | cc/min |
| N₂ | 500 | cc/min | N₂ | 500 | cc/min |
| CO₂ | 88.3 | cc/min | CO₂ | — | cc/min |

At this time, a schematic diagram of the absorption equilibrium device fabricated to measure the carbon dioxide absorption ability (absorption rate) of an acidic gas absorbent is illustrated in FIG. 10. This equilibrium device measures the amount of carbon dioxide absorbed using the vapor-liquid equilibrium principle and is largely divided into a gas supply section, a reaction section, and a data recording section. The gas supply section consists of a supplier (bomb) that supplies gas and a gas cylinder, and the gas supplied from the supplier passes through a filter and is stored in the gas supplying cylinder. At this time, the gas supplying cylinder was installed in a constant temperature bath so as to be maintained at a constant temperature. A pressure transducer (Sensys pressure transmitter Co., N/M: PSHFC100KCAG, 0 to 100 bar, error range: ±0.005%) and a temperature indicator (−40° C. to 180° C., K-type thermocouple, error range: ±0.1° C.) were installed in the gas supplying cylinder so that the temperature and pressure of the gas supplied to the reactor were accurately informed. The gas supplying cylinder has a volume of 220 cc and consists of four cylinders so that a number of absorption experiments can be conducted simultaneously.

The reaction section consists of a reactor in which an acidic gas absorbent absorbs carbon dioxide, and the reactor has a height of 39 mm, an inner diameter of 48 mm, a thickness of 7 mm, and an internal volume of 73 cc. The reactor is installed in a constant temperature bath equipped with an immersing heater so as to be maintained at a constant temperature. As in the gas supplying cylinder, a pressure transducer and a temperature indicator were installed in the reactor so that the accurate pressure and temperature were informed. A vacuum pump was installed outside the reactor so that a vacuum was maintained in the reactor at the beginning of the experiment. A magnetic bar was placed in the reactor to promote the vapor-liquid reaction, and a magnetic stirrer was installed at the bottom of the constant temperature bath to drive the magnetic bar. Four reactors were installed in the constant temperature bath. The data recording section consists of a collection unit that collects data from the pressure transducer and temperature indicator, and a computer equipped with monitoring software so that the experimental results depending on the change in conditions in the gas supplying cylinder and reactor were recorded. Hence, the experimental conditions and changes in temperature and pressure over time were informed in real time.

Prior to an experiment to measure the carbon dioxide absorption rate and absorption speed using an acidic gas absorbent, residual gas inside the gas supplying cylinder and the reactor containing a sample was completely removed using a vacuum pump. Afterwards, the temperatures of the gas supplying cylinder and the constant temperature bath of the reactor were raised to each experimental temperature, then carbon dioxide was injected into the gas supplying cylinder up to the set pressure, and then the state was maintained for 30 minutes to maintain a constant temperature. Afterwards, the valve connected between the gas supplying cylinder and the storage bath was opened to supply carbon dioxide at the set pressure to the reaction bath. When the pressure reached the set pressure, the valve was closed, and the temperature and pressure in the reactor were measured as the experiment time elapsed. As the experiment time elapsed, carbon dioxide in the reactor was absorbed into the acidic gas absorbent and the pressure decreased. Finally, the absorption experiment was terminated when there was no pressure change in the reactor. A magnetic stirrer installed at the bottom of the reactor was used to increase the contact area between carbon dioxide and the acidic gas absorbent in the reactor, and the stirring condition was kept constant at 250 rpm to maintain a constant contact condition during each experiment.

Before the absorption rate was calculated, the volumes of the gas supplying cylinder, gas supplying cylinder line, and storage bath required for calculation of the absorption rate were measured. The Allpros program was used to calculate carbon dioxide absorption rate from pressure changes. The Allpros program can relatively accurately simulate the thermodynamic properties of various gases using dozens of its own parameters. Using the Allpros program, carbon dioxide density values depending on the temperature and pressure conditions can be acquired, and the pressure difference between the initial pressure when carbon dioxide was injected and the final pressure when the absorption reaction reaches the equilibrium state is calculated as the density change, and then the amount of carbon dioxide absorbed is calculated using this.

The following method was used to calculate the carbon dioxide absorption rate using an acidic gas absorbent. First, the volume of carbon dioxide injected into the reactor is the value acquired by subtracting the volume of the acidic gas absorbent injected from the volume of the reactor, and was calculated using the following Formula (1).

$${V}_{{CO}_{2}} = {V}_{cell} - {V}_{IL} {V}_{{CO}_{2}} , {V}_{cell} ( and {V}_{IL} in {dm}^{3} ) \qquad [ Formula 1 ]$$

Here, assuming that w is the molecular weight of carbon dioxide and c is the number of moles per unit volume, the volume of carbon dioxide can be expressed by the following Formula 2.

$${w}_{{CO}_{2}} = 44.095 g / mol \frac{{p}_{1}}{{w}_{{CO}_{2}}} = {c}_{1} , \frac{{p}_{2}}{{w}_{{CO}_{2}}} = {c}_{2} \qquad [ Formula 2 ]$$

c₁ is expressed by the following Formula 3 under the condition when carbon dioxide is not yet injected into the reactor, and c₂ is expressed by the following Formula 3 under the condition when the equilibrium state is completely obtained after injection of carbon dioxide into the reactor.

$$\frac{{p}_{1}}{{w}_{{CO}_{2}}} {V}_{{CO}_{2} \text{.1}} = {c}_{1} {V}_{1} = {n}_{1} \frac{{p}_{2}}{{w}_{{CO}_{2}}} {V}_{{CO}_{2} \text{.2}} = {c}_{2} {V}_{2} = {n}_{2} \qquad [ Formula 3 ]$$

n₁ is the initial number of moles of carbon dioxide injected into the reactor, n₂ is the number of moles of carbon dioxide remaining in the reactor after the reaction with the acidic gas absorbent, and the value acquired by subtracting n₂ from n₁ is the number of moles of carbon dioxide absorbed and is expressed by Formula 4.

$${n}_{1} - {n}_{2} = \frac{( {p}_{1} - {p}_{2} )}{{w}_{{CO}_{2}}} {V}_{{CO}_{2}} = \frac{( {c}_{1} - {c}_{2} )}{{w}_{{CO}_{2}}} {V}_{{CO}_{2}} = {n}_{{CO}_{2}} \qquad [ Formula 4 ]$$

In order to calculate the mole fraction of the acidic gas absorbent into which carbon dioxide was finally absorbed, the number of moles of the acidic gas absorbent was calculated as shown in Formula 5, and then the mole fraction of carbon dioxide absorbed into the acidic gas absorbent was calculated as shown in Formula 6.

$${n}_{IL} = \frac{Mass of IL used ( g )}{Molecular weight of IL ( g / mol )} \qquad [ Formula 5 ]$$

$${x}_{{CO}_{2}} ( {CO}_{2} mole fraction ) = \frac{{n}_{{CO}_{2}}}{{n}_{{CO}_{2}} + {n}_{IL}} \qquad [ Formula 6 ]$$

The foregoing description of the present invention is for illustrative purposes only, and those skilled in the art to which the present invention pertains will understand that the present invention can be easily modified into other specific forms without changing its technical idea or essential features. Therefore, the embodiments described above should be understood in all respects as illustrative and not restrictive. For example, each component described as single may be implemented in a distributed manner, and similarly, components described as distributed may also be implemented in a combined form.

The scope of the present invention is indicated by the claims described below, and all changes or modified forms derived from the meaning and scope of the claims and their equivalent concepts should be construed as being included in the scope of the present invention.

According to an aspect of the present invention, the acidic gas absorbent of the present invention has excellent acidic gas absorption ability and a fast reaction rate as well as the process is simple and economical since an efficient process is adopted so that additional processes such as separation and purification of reactants are omitted to produce the absorbent. The effects of the present invention are not limited to the effects described above, and should be understood to include all effects that can be inferred from the configuration of the invention described in the description or claims of the present invention.

While the present invention has been described with respect to the specific embodiments, it will be apparent to those skilled in the art that various changes and modifications may be made without departing from the spirit and scope of the invention as defined in the following claims.

1. A method for producing an acidic gas absorbent, comprising:
supplying water and ammonia to a first mixer to produce a first mixture;
supplying the first mixture in the first mixer to a second mixer through a first mixer discharge pipe and simultaneously supplying ethylene oxide to the second mixer to form a second mixture;
supplying the second mixture in the second mixer to a reactor through a second mixer discharge pipe and reacting the second mixture under predetermined temperature and pressure conditions to form a third mixture;
supplying the third mixture in the reactor to a first separator equipped with a distillation tower function through a reactor discharge pipe and separating the third mixture into unreacted ammonia, water vapor, and a fourth mixture;
recovering unreacted ammonia and water vapor in the first separator into the first mixer through a first separator distillation tower connection pipe and supplying the fourth mixture to a second separator equipped with a distillation tower function through a first separator discharge pipe and separating the fourth mixture into unreacted water and a fifth mixture; and
recovering a portion of unreacted water in the second separator as water vapor into the first mixer through a second separator distillation tower connection pipe and obtaining the fifth product as an acidic gas absorbent through a second separator discharge pipe,
wherein a molar ratio of ammonia supplied to the first mixer and unreacted ammonia recovered through the first separator distillation tower connection pipe to ethylene oxide supplied to the second mixer is 5:1 to 10:1, and
the predetermined temperature and pressure conditions are 50° C. to 70° C. and 3 to 15 bar, respectively.

2. The method for producing an acidic gas absorbent according to claim 1,
wherein a temperature range in the first separator is 50° C. to 170° C. and a pressure range is 2 to 6 bar.

3. The method for producing an acidic gas absorbent according to claim 1,
wherein a temperature range in the second separator is 80° C. to 150° C. and a pressure range is 0 to 1.2 bar.

4. An acidic gas absorbent produced by the method according to claim 1.

5. The acidic gas absorbent according to claim 4, comprising monoethanolamine at 10 to 60 wt %, diethanolamine at 20 to 70 wt %, triethanolamine at 15 to 60 wt %, and water at 10 to 40 wt % with respect to a total weight.

6. A carbon dioxide capturing method using an acidic gas absorbent, comprising:
preparing an aqueous solution containing an acidic gas absorbent produced by the method according to claim 1 (S100); and
capturing carbon dioxide using the aqueous solution (S200), wherein heat of reaction generated by a reaction between the aqueous solution and carbon dioxide is 74 KJ/mol-CO₂ or less.

7. The carbon dioxide capturing method using an acidic gas absorbent according to claim 6,
wherein the aqueous solution in step S100 contains the acidic gas absorbent at 50 to 60 wt %.

8. The carbon dioxide capturing method using an acidic gas absorbent according to claim 6,
wherein step S200 involves capturing carbon dioxide in a temperature range of 30° C. to 50° C. and a pressure range of 1.5 bar or less.

9. The carbon dioxide capturing method using an acidic gas absorbent according to claim 6,
wherein an absorption rate is 0.0024 mol CO₂/min or more when 10 minutes has elapsed after exposure of the acidic gas absorbent to carbon dioxide in step S200.

10. The carbon dioxide capturing method using an acidic gas absorbent according to claim 6,
further comprising desorbing the captured carbon dioxide and regenerating the acidic gas absorbent (S300) after step S200.

11. The carbon dioxide capturing method using an acidic gas absorbent according to claim 10,
wherein the acidic gas absorbent has a maximum desorption rate of 0.0020 mol CO₂/min or more and 0.0025 mol CO₂/min or less in step S300.

12. A method for producing an acidic gas absorbent, comprising:
supplying water and ammonia to a first mixer to produce a first reactant;
simultaneously supplying ethylene oxide and the first reactant to a second reactor through a supply pipe connected to a first connection pipe that supplies the first reactant in the first reactor to the second reactor to form a second reactant;
supplying the second reactant in the second reactor to a third reactor equipped with a distillation tower function through a second connection pipe and separating the second reactant into unreacted ammonia and a third reactant;
recovering unreacted ammonia in the third reactor to the first reactor through a third connection pipe, supplying the third reactant to a fourth reactor equipped with a distillation tower function through a fourth connection pipe, and separating the third reactant into unreacted water and a fourth reactant; and
recovering unreacted water in the fourth reactor to the first reactor through a fifth connection pipe and obtaining the fourth reactant as an acidic gas absorbent through a fourth reactor discharge pipe,
wherein a molar ratio of total ammonia, including ammonia supplied to the first reactor and unreacted ammonia recovered through the third connection pipe, to ethylene oxide supplied through the supply pipe is 5:1 to 10:1.

13. The method for producing an acidic gas absorbent according to claim 12,
wherein a temperature range in the second reactor is 50° C. to 70° C. and a pressure range is 0.5 to 1.5 MPa.

14. An acidic gas absorbent produced by the method according to claim 12.

15. The acidic gas absorbent according to claim 14,
comprising monoethanolamine at 20 to 70 wt %, diethanolamine at 10 to 20 wt %, and triethanolamine at 5 to 75 wt % with respect to a total weight.

16. An acidic gas absorbent produced by the method according to claim 2.

17. An acidic gas absorbent produced by the method according to claim 3.

18. An acidic gas absorbent produced by the method according to claim 13.
